(19) United States
(12) Patent Application Publication
(10) Pub. No.: US 2022/0374991 A1
(43) Pub. Date: Nov. 24, 2022

(54) COVERAGE ANALYSIS BASED ON INDIVIDUAL PATIENT SINGULAR/SERIES ARRAY DATA AGGREGATED FROM DISPARATE DATABASES

(71) Applicant: eAssist, Inc., American Fork, UT (US)

(72) Inventors: James Victor Anderson, American Fork, UT (US); Jason Orgill, Idaho Falls, ID (US); Alexis Ryan Ashley, Queen Creek, AZ (US); James C. DiMarino, Ocean City, MD (US)

(21) Appl. No.: 17/664,386

(22) Filed: May 20, 2022

Related U.S. Application Data
(60) Provisional application No. 63/191,283, filed on May 20, 2021.

(51) Int. Cl. G06Q 40/08; G06Q 10/10

(52) U.S. Cl. CPC G06Q 40/08; G06Q 10/10

(57) ABSTRACT

Systems and methods are described herein to aggregate data from multiple insurance companies and generate a treatment plan report with expected patient co-pays that are adjusted, estimated, and provided as ranges of expected co-pays based on the quality of the source of the coverage information and/or based on historical co-pays for patients with similar insurance coverage and treatment plans.

### RELATED APPLICATIONS

This application claims priority to U.S. Provisional Patent Application No. 63/191,283 titled “Coverage Analysis Based On Individual Patient Singular/Series Array (SSA) Data Aggregated From Disparate Databases” and filed on May 20, 2021, which application is hereby incorporated by reference in its entirety.

### TECHNICAL FIELD

This disclosure relates to dental, medical, veterinary, insurance, legal, and other industries in which patients or clients are billed for goods and services provided by a professional in the field.

### BRIEF DESCRIPTION OF THE DRAWINGS

FIG. 1 illustrates an example of a treatment plan, according to one embodiment.

FIG. 2 illustrates a block diagram of communication channels between a general dentist and two specialists, according to one embodiment.

FIG. 3 illustrates an example of another treatment plan, according to one embodiment.

FIG. 4 illustrates a block diagram of an interaction between an insurance company and a general dentist, according to one embodiment.

FIG. 5 illustrates a block diagram of interactions between multiple parties, according to one embodiment.

FIG. 6 illustrates another block diagram of interactions between multiple parties, according to one embodiment.

FIG. 7 illustrates a matrix of singular/series arrays (SSA), according to one embodiment.

FIG. 8A illustrates a block diagram of interactions and communications to aggregate data to generate individual patient or client SSAs, according to one embodiment.

FIG. 8B illustrates another block diagram of interactions and communications to aggregate data to generate individual patient or client SSAs, according to another embodiment.

FIG. 9A illustrates an example of a treatment plan presenter (TPP), according to one embodiment.

FIG. 9B illustrates an example of another treatment plan presenter (TPP) with co-pay ranges based on associated trust scores, according to one embodiment.

FIG. 10 illustrates a block diagram of one implementation of various embodiments of the system described herein, according to one embodiment.

### DETAILED DESCRIPTION

There are several fields in which the various embodiments described herein can be utilized including but not limited to: medical, dental, veterinary, insurance, legal, etc. In the field of dentistry, for example, many dental offices interact with their patients' dental insurance carriers. In the various examples described herein, the first insurance carrier is sometimes referred to herein as “I1” and the dental office is sometimes referred to as “DO”. In some instances, a patient may have a secondary dental insurance carrier sometimes referred to as “I2” and primary and/or secondary medical insurance carriers or additional source for which one may need to review and/or coordinate benefits, sometimes referred to herein as “I3”. A dental office will often connect with first insurance carrier, and/or second insurance carrier and/or additional insurance carriers to verify if the patient has dental and or medical insurance coverage, the effective date of said insurance, obtain the insurance benefit details, and coordinate benefits between primary and secondary dental and/or primary and/or secondary medical benefits if desired.

Although the dental patient may provide dental office with an insurance card, if often does not provide the level of detail dental office requires to accurately verify and estimate the patients' and insurance carriers' financial obligations.

Therefore, dental office must contact the first insurance carrier to receive the necessary information via one or more data retrieval sources, such as via email, phone call, a fax back, etc., all of which are helpful but require an investment of time by dental office and may still result in a lack of required information to proceed which causes the cycle to repeat until the discovery is complete.

Another problem inherent in the current process is imparting errors. If the data exchanged between a dental office and a first insurance carrier, a second insurance carrier, and/or a third insurance carrier is out of date or subjected to human error, the patient and insurance billing estimates may be wrong. These billing errors can cause frustration, anger, and distrust between the patient, the dental provider and/or the insurance carrier(s) and often results in one of the three feeling like they were forced to overpay.

Currently, dental office must verify their patients' benefits before they can present their patients with a treatment plan which outlines the insurance and patients' financial responsibilities. Often, this is a manual process which requires time and attention to detail by the dental office operator and numerous encounters with first insurance carrier, second insurance carrier, and/or third insurance carrier+.

If any errors are made in the manual entry of the information obtained from the first insurance carrier, the second insurance carrier, etc. (e.g., as manually entered into a ledger, database, computer system, file, or other repository), the dental office operator will unknowingly provide their patient with erroneous financial projections. The mistake may not become evident for days, weeks, or months. This error puts the dental office operator in a bad position with the dental office patient when a balance is discovered to be owed which often results in the dental office writing off the balance while also causing the patient to distrust their health care provider. Alternatively, the dental office may contact the first insurance carrier, the second insurance carrier, and/or the third insurance carrier, etc. to contest, request an appeal, or express their distrust, frustration, and/or anger for the misinformation. The dental office and the insurance company(ies) must negotiate to convince the other who should either pay or write off the disputed fee and, depending on the result, could lead to the dental office not trusting the insurance company(ies) and terminating their participation.

If the dental office operator determines that the error was the fault of incorrect information provided by the first insurance carrier the second insurance carrier, and/or the third insurance carrier, the first insurance carrier the second insurance carrier, and/or the third insurance carrier must determine if they write off the error. Both of the aforementioned cases would benefit from accurate, real-time information being shared between the insurance company(ies), the dental office and the patient in a manner that avoids human interaction/error.

Even when accurate information can be exchanged, the policies regarding the interplay and payments of multiple insurance companies may not be clearly defined or established. In some instances, the only way to learn about how claims are processed by various insurance companies is by analyzing how the actual claims are processed. For example, two insurance companies may each state that they pay half of the cost of a crown; however, it may not be clearly defined what will happen if the patient is covered by both insurance companies. In one scenario, the first insurance company pays for 50% of the crown and the second insurance company pays the other 50%. In another scenario, the first insurance company pays for 50% of the crown, the second insurance company pays for 50% of the remaining balance, and the patient pays the remaining 50%. In another scenario, each insurance company may pay for 25% of the crown, leaving the patient to pay for the remaining 50%. Do to the complexity of insurance billing, the interactions between multiple dental and health insurance companies, and the overlapping coverage provisions of each individual coverage policy, it is sometimes not possible to determine an exact co-pay amount that will be owed by a patient by simply asking each of the insurance companies.

Another problem inherent in the current process is providing an estimate of coverage, costs, and the plan design as it relates to the treatment plan of a general dentist especially when the treatment plan includes a patient referral to one or more specialists. If a patient needs dental treatment of fillings, a root canal, extraction of wisdom teeth, etc., for example, it is the responsibility of the dental office to provide a treatment plan to the patient. The treatment plan must provide an option of treatments the dental office is recommending for the patient based on the examination and the patients' needs. The treatment plan may include work the dental office will complete as well as a referral to a specialist or specialists for work they will do such as a root canal specialist called an endodontist (S1) for molar root canals or a specialist that extracts impacted wisdom teeth called an oral surgeon (S2) for example. In cases where a specialist or group of specialists may be needed, the dental office will have to communicate with S1, S2, S3, etc., the endodontist, oral surgeon, and/or other specialists to determine how much their treatment is going to cost so the dental office can determine if the patients' insurance maximum can cover the most emergent dental treatment needed and how much will remain thereafter so the dental office can prioritize the patients' treatment.

Currently, it is exceedingly difficult and often unpredictable to determine if a patients' insurance will cover emergent care especially if multiple providers are involved. If one also adds multiple insurance carriers, accurately predicting insurance and patient financial obligations becomes even more cumbersome. Therefore a need exists to create a system that can provide an accurate estimate of what one or multiple insurance plans will pay for treatment at one or multiple providers' offices so that a patient will be able to not only know if emergent care will be financially feasible but also to accurately determine how much insurance will pay in an entire benefit cycle so that the patient can address their emergency and long-term needs in a predictable manner.

As stated, the systems and methods described herein are applicable to many disciplines, however in order to provide an example of a possible application, an embodiment that pertains to the field of dentistry will be shared. The presently described systems and method offer solutions that utilize computer mapping technologies to combine information from multiple insurance companies and/or multiple providers to aggregate data from disparate databases, individuals, fax back records, email requests, etc. Singular series arrays (SSAs) are used as a data structure to store and provide access to aggregated data. In some embodiments, machine learning and artificial intelligence subsystems are used to estimate the costs associated with various treatments plans. Calculated values and other data may be compared with processed claims stored in a database to see if the calculated results are harmonious with past results of historical processed claims stored in a processed claim database.

A trust score may be associated with each estimate of costs and the final cost presented to a patient may include a trust score. In other embodiments, the trust score may be used to provide a range of possible payments associated with a treatment plan based on trust score thresholds. For example, a trust score information may be used to provide a worst-case scenario of the total cost assuming that the expected costs with a trust score above a threshold value (e.g., 75) are accurate and a best-case cost estimate assuming that estimated insurance coverage associated with lower trust scores are paid. Some insurance coverage estimates may be in the form of a minimum coverage estimate with a trust score of 100 (maximum) and an expected or possible coverage estimate with a lower trust score (e.g., 50), and an expected or possible coverage estimate with an even lower trust score (e.g., 25). In such an embodiment, the coverage estimate provided to in a treatment plan to the patient may include a best case scenario that includes all three possible payment/coverage outcomes.

Insurance companies create insurance packages which they offer to employers outlining what the insurance will cover for each of the hundreds of American Dental Association's Current Dental Terminology (hereafter “ADA CDT”) codes. In order for the employer to make an informed decision for their employees, the insurance companies offer a breakdown of benefits, maximum allowable charges, deductibles, maximum benefits, etc. (hereafter “Plan”) with great specificity. Once the employer decides which insurance Plan to purchase, the role of the insurance company is to administer the Plan benefits that the employer purchased. In order to do so, the insurance company must follow a specific set of standards (Plan) that is outlined in the insurance policy which the employer purchased.

Dental offices review their patients' plan to determine what their patients' insurance will cover in order to help their patients know how much their dental Plan will cover for the dental treatment and what the patients' financial obligation will be.

The systems and methods described herein allow the dental office to connect with first insurance carrier, second insurance carrier, and/or third insurance carrier in a manner that allows the dental office to clearly verify their patient's insurance eligibility and benefits as well as the plan details so an accurate estimate of the financial obligations of all partiers can occur in real time without the need to contact the insurance company(ies) repeatedly and/or speak with an insurance company or companies' representative who could introduce human error unknowingly and unintentionally.

In various embodiments of systems and methods described herein, the dental office's infrastructure is modified to seamlessly sync/access the insurance company(ies) Plan without the need for human involvement/possibility of human error using Dynamic Custom Logic (hereafter “DCL”).

The reason the DCL process is so unique is that it simplifies the following process that is currently used: an employee or employees at the dental office must invest significant time to connect with at least one or more insurance company(ies) before each of their patients' dental appointments in order to verify the patients' insurance and obtain the Plan details to sync the dental office patient's benefit details in to dental office's practice management software system or Office Record Keeping System (hereafter “ORKS”) without introducing human error. Additionally, if the dental office determines that the patient is in need of specialist services, an employee or employees at the dental office must invest significant time to connect with at least one or more specialists' offices to gain clarity on the costs of the specialty treatment and then connect with the insurance company(ies) before each of their patients' dental appointments in order to verify the patients' insurance and obtain the Plan details.

In various embodiments of the systems and methods described herein, the dental office is provided with the most up to date information needed to allow the dental office to provide their dental and/or medical insurance company(ies) anticipated payment so the dental office can provide the patient with their financial obligation based on the treatment needed and the allowable/eligible insurance remaining as accurately provided by the insurance company(ies) in real time, in a learning environment, while also avoiding the introduction of human error.

The DCL can be utilized to sync whatever information is desired between 1, 2, or more users.

This synchronous interaction is free of human interaction and greatly increases the efficiency of all users while also decreasing the risk of requiring any party to write off a balance. This enhances the patient's experience and instills confidence in the patient-health care provider relationship since the amount the patient was projected to owe for the treatment is in fact the amount the patient paid. Additionally, this improved process allows the patient to maximize their insurance benefits across multiple insurance carriers as well as providers so the patient can obtain the best possible treatment available.

In some embodiments of the systems and methods described herein, the DCL can include a singular or a series of arrays (hereafter “SSA” for Singular/Series of Arrays) that allow for further customization. Array #1, for example, might be used to populate a patient's primary dental insurance. If the patient also has a secondary dental insurance, another array would be created. Additionally, a third, fourth, or more array(s) may be created to include the patient's primary and secondary medical insurance or as many arrays as is needed.

A Code Compilation Component (hereafter “CCC”) may be a system, a subsystem, or a module that allows the DCL to work with the SSA to provide an estimate of coverage wherein the coordination of benefits occurs. The CCC overcomes one of several hurdles in the patient verification and insurance estimate environment by estimating what a patient's primary/secondary dental insurance and/or primary or secondary medical insurance (for example) may pay and what the patient's obligation will be.

Currently, many patients who have dual coverage and/or medical and dental coverage rarely coordinate benefits which means they either pay too much for a procedure or avoid a procedure thinking their co-pay may be too expensive. The DCL and the CCC combine to overcome these challenges by coordinating both primary and secondary dental and medical insurance so that the patient maximizes their insurance coverage, only pays the appropriate amount required, and can then make an informed decision to proceed or not with treatment based on the medical/dental benefit. This embodiment also allows the dental office and patients to track their use of insurance so that by October or November of each year, they can easily determine how much of their insurance has been unused and can plan treatment so that the patient can maximize their yearly insurance benefits and the dental office can maximize their Q4 operations.

There are many fields to which the embodiment can be applied, below describes how the embodiment may be implemented in the field of dentistry.

A specific example of a potential use case for the system defined herein, is explained next in the field of dentistry with the assistance of drawings. In the field of dentistry, each treatment has an American Dental Association Current Dental Terminology Code (hereafter “ADA CDT”) assigned to the procedure which starts with the letter D and to which insurance companies and dental providers assign/charge a fee. In this example,

(a) A new patient enters a general dentists' office seeking dental care

(b) The dental office provider examines the patient which will be recorded using the ADA CDT code D0150—Comprehensive Oral Exam.

(c) The dental office provider orders a Full Mouth Series of Radiographs (D0210)

(d) The dental office provider completes an adult prophylaxis otherwise known as a “dental cleaning” (D1110) and creates a treatment plan which includes the following:
(di) Extraction of an impacted wisdom tooth #1 which is causing the patient pain, is infected, and swollen for which the patient has requested the use of General Anesthesia (D9222 and D9223).
(dii) Tooth #2 is infected, painful, and the gum around it is swollen.
   (dii1) For each finding, a dental office provider is required to offer their patient treatment options so the patient can determine which solution is best for them. We will use tooth #2 to show how this often plays out between a patient and the dental office. Here are the two options presented to the patient:
      (dii1a) Option 1: Root Canal Treatment (hereafter “RCT”) due to pain, infection, and swelling. (D3330).
      (dii1b) Option 2: Extraction due to pain, infection, and swelling. (D3330).
   (dii2) Often, the patient will ask:
      (dii2a) What does my insurance cover for the RCT?
      (dii2b) How much will I have to pay for the RCT?
      (dii2c) If my insurance covers the RCT and I only have to pay $1 or less, I want to keep tooth #2 and will chose the RCT option.
      (dii2d) If my insurance does not cover a RCT, I want it extracted.
(diii) Crown on tooth #3 (D2740)
(div) Onlay on tooth #4 (D2642). The patient decided they will agree to the onlay only if their insurance covers it and their co-pay is less than $1.
(dv) Composite Filling on tooth #5 (D2391)

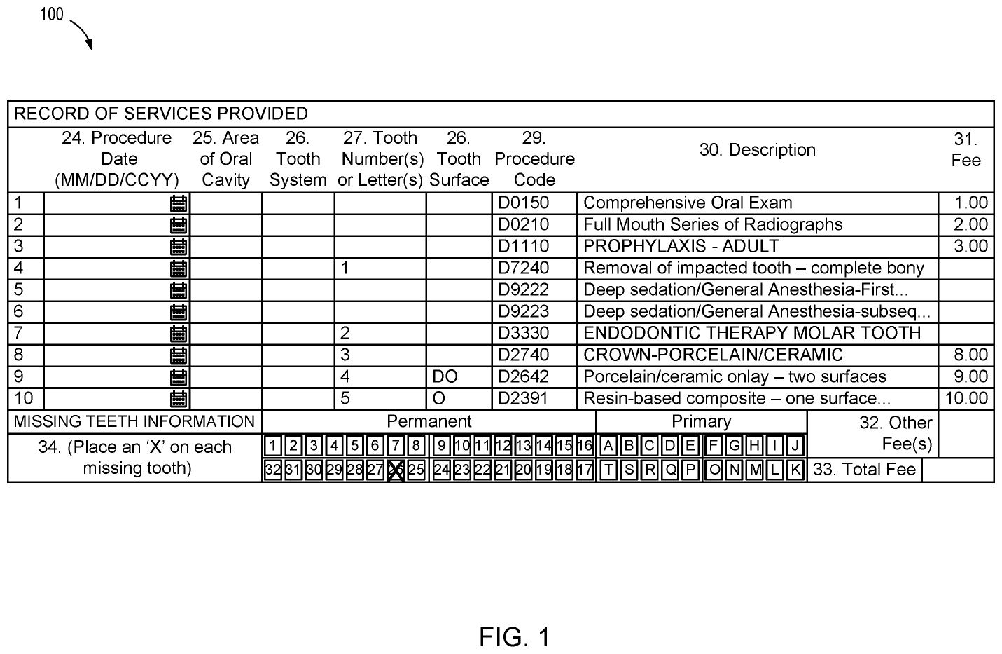

FIG. 1 illustrates an example of a treatment plan 100, according to one embodiment. There are several steps the dental office must then take to be able to answer the patient's questions. The first thing is to input the aforementioned treatment into their ORKS which would produce a treatment plan 100 as illustrated.

The dental office provider may decide to refer the patient to a specialist or specialists for certain procedures. In this case, the dental office provider has elected to refer the patient to an Oral Surgeon (S1) to extract the impacted tooth #1 and to an Endodontist (S2) for a root canal treatment for tooth #2 if the patients' insurance company covers the RCT and the patient's co-pay is less than $1. If not, the provider will add the extraction of tooth #2 to the referral to S1. Since the dental office knows how much they charge for the treatment that will be rendered in their office, they can input the fees as shown in column #31 in the illustrated treatment plan 100.

In order to obtain the fees for the specialists, the dental office must contact the specialist(s) and provide the necessary patient documentation/information so the specialist(s) can share their fees for the treatments for which the dental office provider is referring the patient. NOTE: the dental office must get two fees from S1, one for the extraction of the impacted tooth #1 and one for the extraction of tooth #2 in case the insurance company does not cover the RCT for tooth #2 or the patients' co-pay exceeds $1. Various embodiments utilize a system for sharing and exchanging information with not only insurance carriers but also specialists so that this process can occur in real-time and be pulled into the dental offices' ORKS.

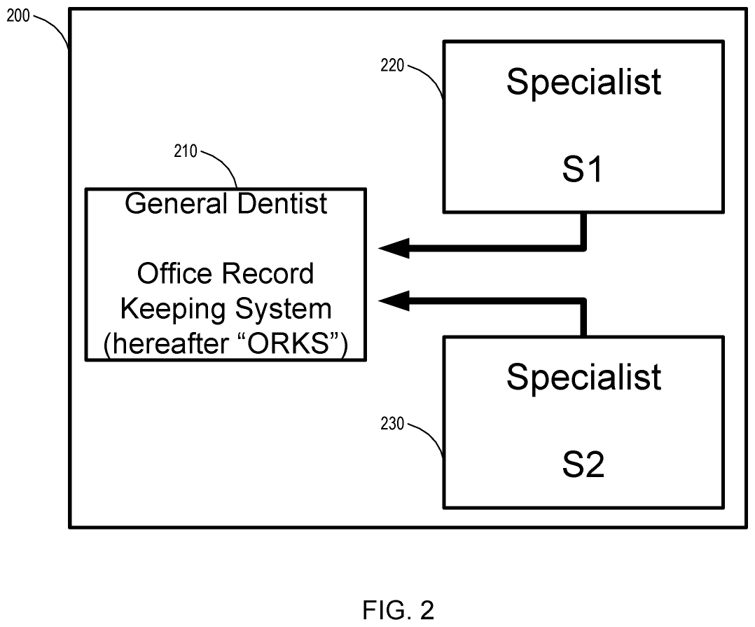

FIG. 2 illustrates a block diagram 200 of communication channels between a general dentist 210 and two specialists 220 and 230, according to one embodiment. The dental office 210 now may request the necessary information from each of the specialists 220 and 230 and add the information to their ORKS. To accomplish this objective, the dental office 210 must reach out to the specialists 220 and 230 via a specific S1, S2, etc., URL, API, or the dental office 210 must email, call or use a fax back system for EACH specialist 220 and 230. Once the dental office 210 inputs all the fees from the patient(s) specialist 220 and 230 into their ORKS, the dental office 210 can update their treatment plan.

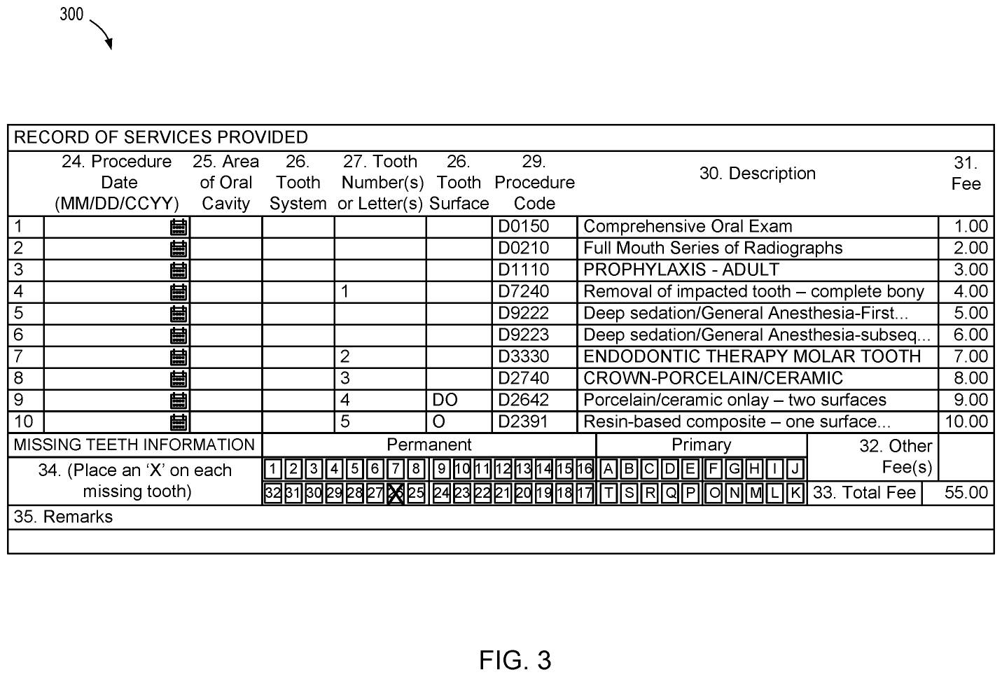

FIG. 3 illustrates an example of the updated treatment plan 300, according to one embodiment. As illustrated, relative to FIG. 1, the fees in column #31 in the treatment plan 300 shows the complete treatment plan with the fees from the specialists in place.

Now that the dental office has the treatment plan and the fees from the specialists and the general dentist, the dental office will then need to reach out to the insurance carrier(s) to obtain information, a few pieces of which is shared below:
(a) Verify that the patient does, in fact, have insurance coverage with the insurance carrier,
(b) When the patients' effective date started with the carrier
(c) Deductible
(d) Annual maximum
(e) what ADA CDT codes are covered and what the maximum allowable charge is
(f) etc.

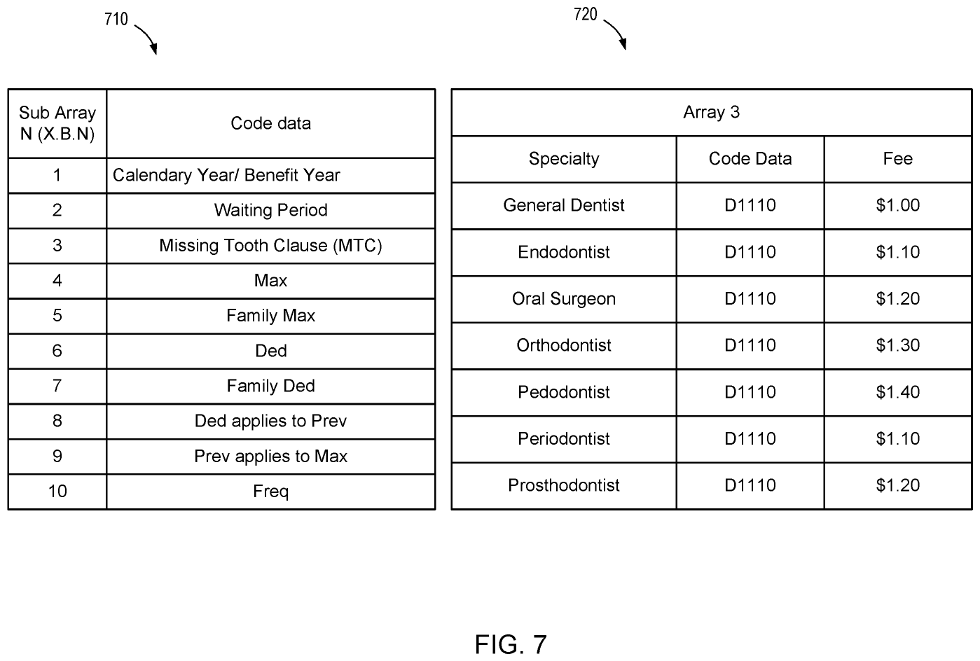

According to various embodiments, the system may utilize the information, including one or more of information items (a)-(f) above, to generate an array, such as the example array illustrated in FIG. 7, as described in great detail below.

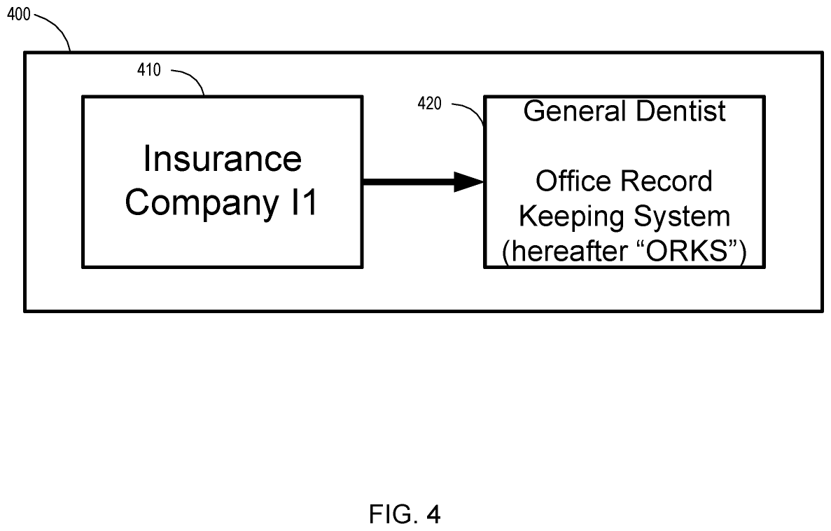

FIG. 4 illustrates a block diagram 400 of an interaction between an insurance company 410 and a general dentist 420, according to one embodiment. This basic connection is the current arrangement in most dental offices. Specifically, the information the dental office needs to obtain from first insurance carrier must be added to a specific area in the dental ORKS, which currently occurs mostly manually.

In order for the dental office to get the necessary information into their ORKS, it must obtain the information from first insurance carrier via a specific first insurance carrier URL, API, or the dental office must email, call or use a fax back system and often typed into the ORKS

As described previously, the process of obtaining the necessary information consumes employee(s) time and often introduces human error which may cause the insurance carrier(s), the dental provider, the specialist(s), and/or the patient to be forced to pay or write off any balances that were erroneously calculated due to errors in this process. Offices often rely heavily on human's manually scraping the information from the insurance carrier(s) and inputting it into their ORKS or on APIs or a hybrid thereof. If a dental office is also relying on APIs then bridges have to be created, updated, and managed for each dental insurance carrier to input the information into the dental office's specific ORKS and often only provide a snapshot of the data required which forces the dental office to pick up the phone to call the insurance carrier(s) to request the missing information.

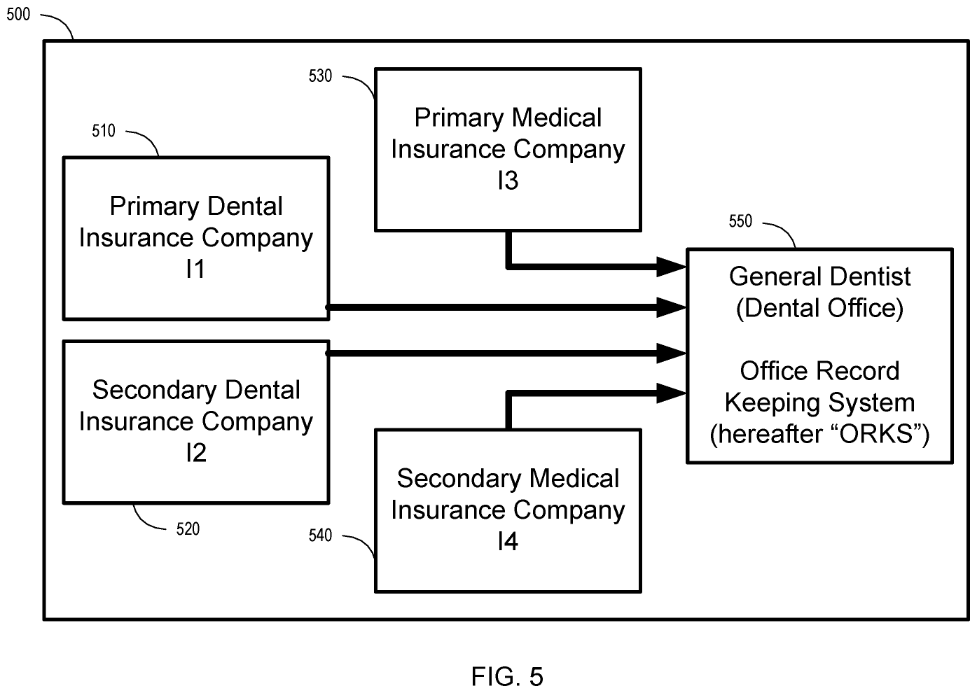

FIG. 5 illustrates a block diagram 500 of interactions between multiple parties, according to one embodiment. The process is more complex if a patient has multiple insurance carriers 510, 520, 530, and 540. Now, in order for the dental office 550 to get the necessary information into their ORKS, it must obtain the information from first insurance carrier 510, second insurance carrier 520, third insurance carrier 530, and fourth insurance carrier 540 via four (4) different, specific URLs for each insurance carrier, four (4) different APIs, or the dental office must email, call or use a fax back system four or more times.

This is process is time consuming and could be fraught with human error which often results in inaccurate financial estimates, frustration, and delay or avoidance of completing necessary dental care. After the dental office 550 receives the required information from the specialists and the insurance carriers, the dental office must then review all the information.

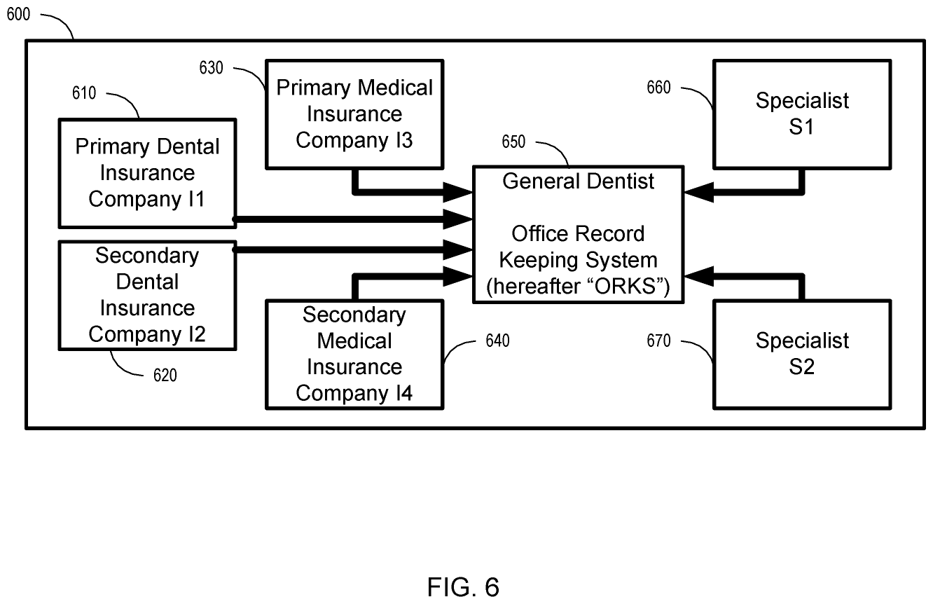

FIG. 6 illustrates another block diagram 600 of interactions between multiple parties 610, 620, 630, 640, 650, 660, and 670, according to one embodiment. As illustrated, a dental office 650 must analyze to determine what insurance will cover and what the patient's financial obligation will be so the dental office 650 can present a summary to the patient in a manner the patient can understand so the patient can determine which treatment options to select.

If any information from any of the sources is misunderstood, misinterpreted, or misconstrued by the dental office 650, the summary will be incorrect. If the summary is incorrect:
(a) the patient may elect a treatment option or choose not to have treatment based on this faulty summary.
(b) and the summary erroneously states that the patient's co-pay for the RCT is $3 which is over the patients' threshold, the patient may elect to extract the tooth when, in fact, the patients' co-pay was only $1 which is under the patients' threshold and means the patient could have saved the tooth with a RCT.
(c) because the dental office did not check with the patients' secondary dental insurance which would have covered the remaining balance of the RCT which the primary insurance did not cover, the patient would have had no co-pay for the RCT and would have saved more of their maximum which means insurance would possibly pay toward for additional treatment such as the crown on #3.
(d) the patient may be presented after completing treatment with a bill larger than what was initially estimated
   a. The patient may be upset, lose faith/confidence in the provider and dental office, may refuse to pay which may further corrupt the relationship, may leave a bad review on social media, may even initiate legal action against the insurance carrier and/or the provider, etc.
   b. The dental office may choose to write off the amount in question, pursue collection actions against the patient, or take action against the insurance company.
   c. If either or both the patient and/or provider contact the insurance carrier, report the insurance carrier to the state board, or take legal action against the insurance carrier, the carrier would have to investigate and may have a recording to review. Ultimately the insurance carrier could pay the provider if the recording in fact shows that the insurance agent provided false information, or, alternatively refuse to pay the provider if the agent did provide the correct information and the dental office representative misunderstood, misreported, or in fact made an error when inputting the information in to the dental office's ORKS.

This example shows how much work must go into obtaining the correct information from the insurance carrier(s), general dentist, and specialists and how critical it is that that information is correctly added to the dental office's ORKS. Even when all is done correctly, treatment options, insurance coverage, and patient co-pays need to presented in a fluid, up to date, and easy to understand manner so that the patient can make a treatment decision that is balance between what they can afford and what they need/desire.

Therefore, it is important for a dental office to provide an accurate summary. If accurate, the summary can help the patient maximize their insurance coverage, treat as many oral concerns as possible, and know how much their co-pay will be for said treatment. Inaccurate summaries can also harm the patient my causing the patient to delay needed treatment due to the cost which could ultimately cause needless pain, suffering, and/or more extensive/expensive treatment due to the delay.

Therefore, there is a need for a system that:
(a) Represents a design choice in which creating a self-learning technology was chosen over the current, flawed, and limited human-API hybrid.
(b) Provides a specific neural network architecture like a feedforward neural network, a convolutional neural network, a modular neural network (or other machine learning or artificial intelligent system)
(c) That continually learns and dynamically adapts to each dental office, insurance company, and specialist (such that each dental office experiences a uniquely trained system) and/or the system learns globally from all users such that all dental offices can experience the same benefits from a system that is continually improving.
(d) Overcomes the challenges dental offices now have even if they could create APIs to sync data in real time with the hundreds of insurance carriers, over 180,000 dentists in the USA alone, with the dozens of ORKS on the market so that the dental office can summarize and present treatment plan options with a high degree of specificity, accuracy, and fluidity so patients can choose from several different treatment plans or different specialists in real time. Currently dental offices do not have an option to allow their ORKS to simply send an API request to the insurance company's API and or Specialists and get the information they need and if they could, they would have to create APIs for the hundreds of insurance carriers, thousands of specialists, and obtain and manage the information.
(e) Provides patients with options and prices for specialists within the geographic area of the general dentist so the patient can choose the specialist that provides the best pricing, best care, or a combination thereof.
(f) Creates arrays for each of the data sets that holds the required information to create the patient treatment plan based on which insurance the patient has.
(g) These arrays will house the data for each of the insurance plans and then be fed into an aggregator or the Code Compilation Component (hereafter “CCC”) which is then used to compile the information, learn from previous experiences, ask for human input when stuck so it can learn how to overcome the challenge in the future and present a treatment plan based on the output settings the dental office selects.
(h) dental office staff have not had the time, resources, technology, or the ability to do the many aspects of the systems described herein.
(i) The systems and methods described herein provide a technological solution that presents as an output that the patient can understand by dynamically providing treatment options since we have the ability to provide real-time data, options, and alternative scenarios.
(j) A user interface that provides usable information gathered from a matrix of all the arrays which allows us to dynamically produce the outcomes of how much the total treatment will cover, which is not currently possible to provide from a human.
(k) Utilizing the information collected to coordinate insurance benefits and accurately predicting insurance and patient financial obligations.

FIG. 7 illustrates a matrix of singular/series arrays (SSA) 710 and 720 used to organize and arrange data aggregated from disparate databases that may communicate and store data using disparate protocols, languages, and the like, according to one embodiment.

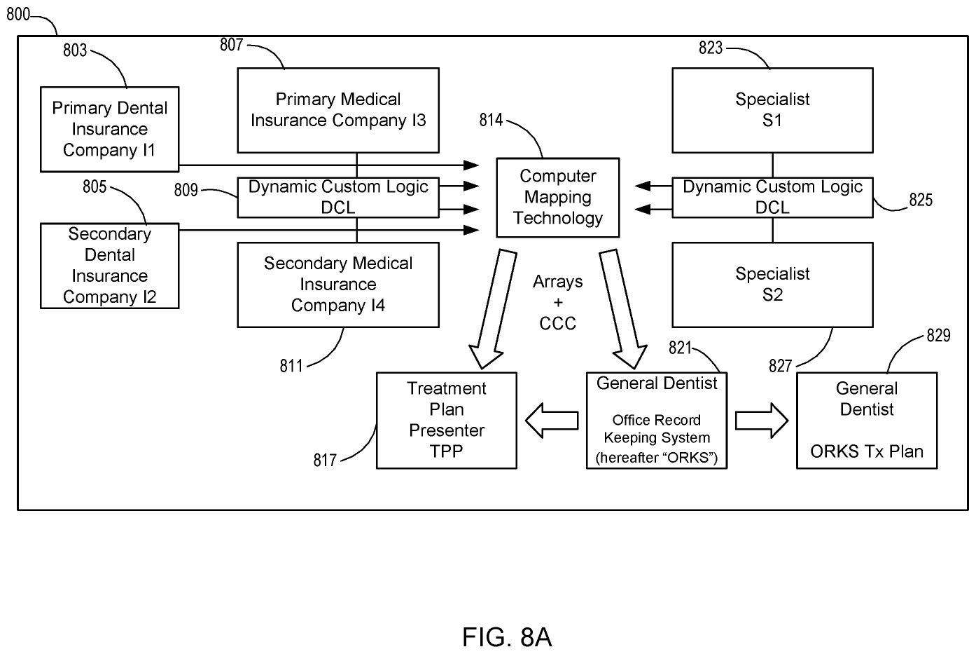

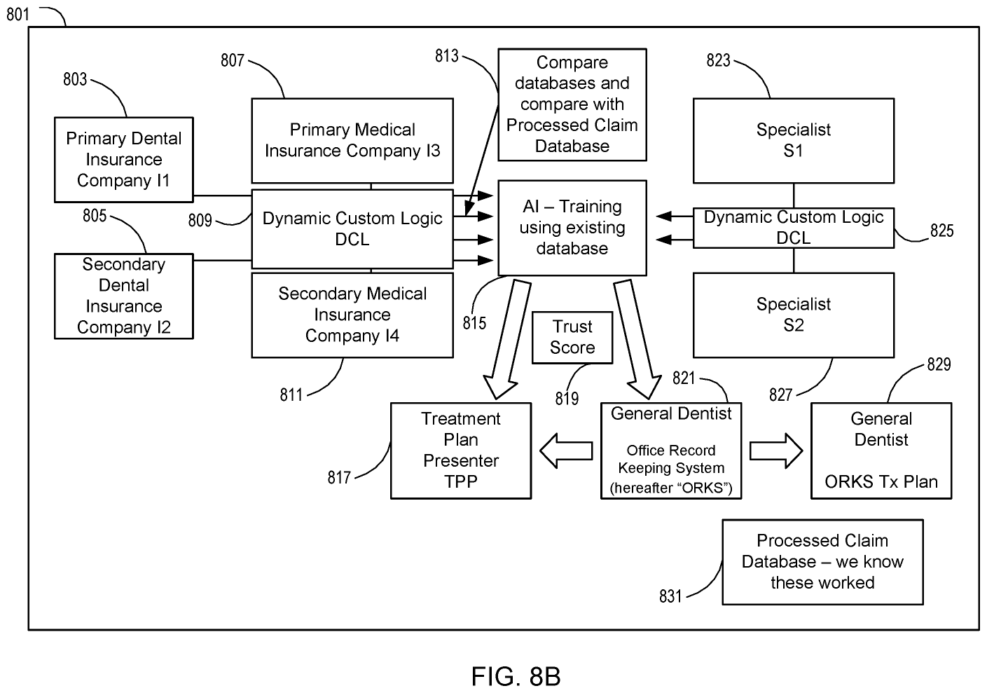

FIG. 8A illustrates a block diagram 800 of interactions and communications to aggregate data to generate individual patient or client SSAs, according to one embodiment. As illustrated, FIG. 8A shows an embodiment that may utilize CCC, computer mapping technology 814 (hereinafter “CMT”) and/or DCL 809 and 825 to synchronize, update, and exchange the data from insurance company(ies) 803, 805, 807, 811, and specialist(s) 823 and 827 into arrays, which are converted by the CMT 814 directly into a usable form for the dental office 821 and seamlessly inputted into the dental office's ORKS 829.

A treatment plan presented 817 can present the treatment plan with estimated costs and coverage amounts. This process is designed to occur in real time so that the precise information is shared without human interaction and the chance of human error.

FIG. 8B illustrates another block diagram 801 of interactions and communications to aggregate data to generate individual patient or client SSAs, according to another embodiment. The illustrated embodiment utilizes a CMT 815 that incorporated or otherwise leverages artificial intelligence and machine learning. Information aggregated by the DCL 809 from the insurance companies 803, 805, 807, and 811 can be compared with databases, such as processed claim database 831 to verify the accuracy of the information and how well it comports or matches with the actual results of previously processed claims. Additionally, a trust score 819 may be generated by the CMT 815 based on the source of the information and/or how well it matches with previously processed claims.

The trust score 819 may be used to develop a treatment plan by the treatment plan presented 817. For example, data associated with a high trust score may be used with confidence to provide exact cost estimates. Data and calculations associated with a low trust score may be used with less confidence or included as a range when providing cost and coverage estimates. In various embodiments, a Treatment Plan Presenter 817 (hereafter: “TPP”) which may be embodied as a system, a subsystem, or a module, allows the dental office to present the treatment plan in a clear, concise manner.

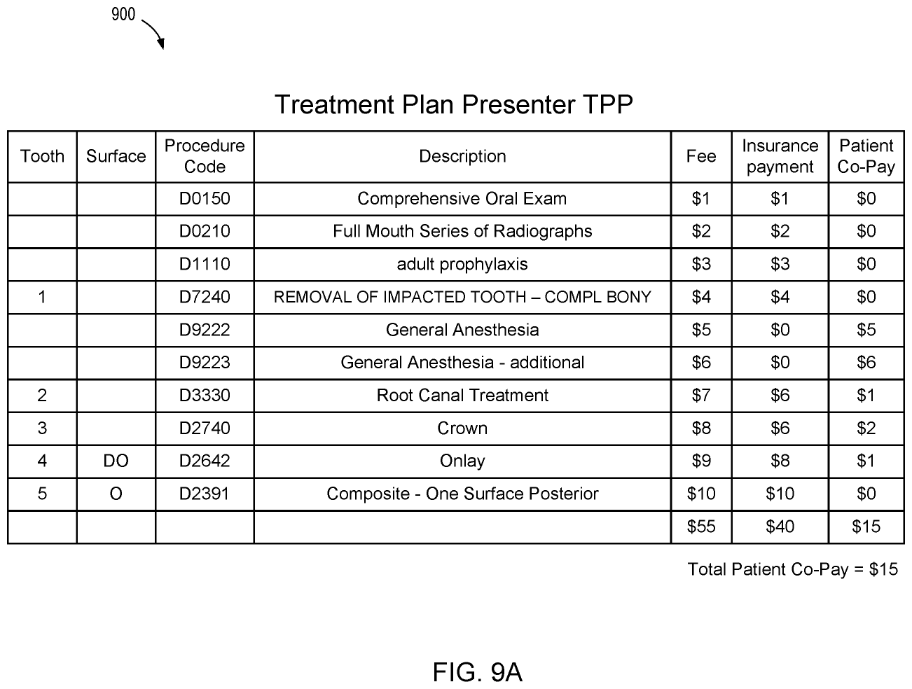

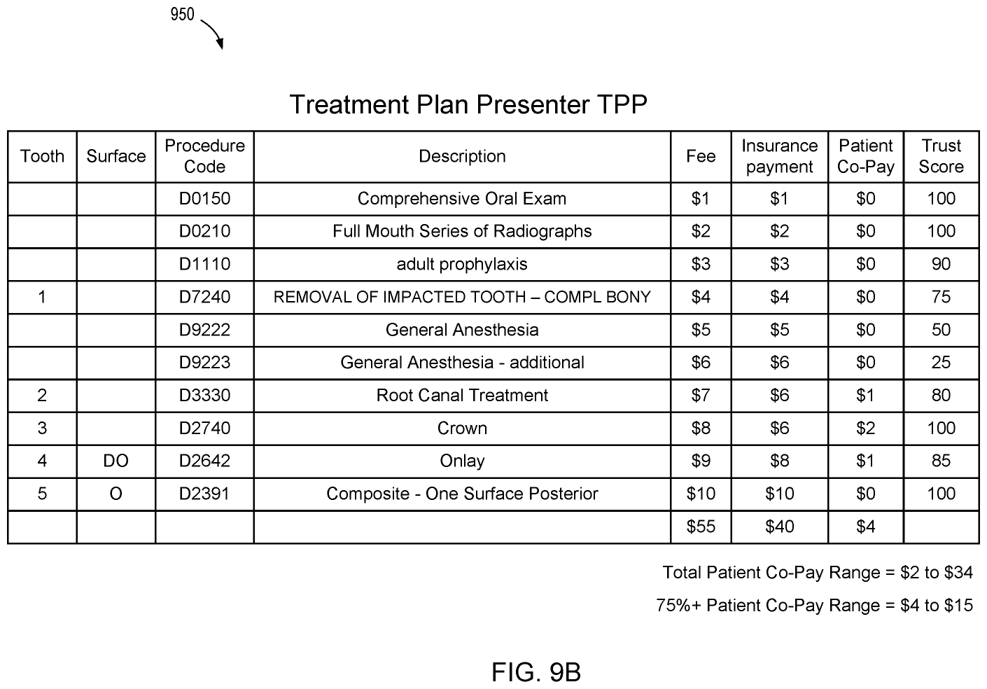

FIG. 9A illustrates an example of a treatment plan 900 generated by a treatment plan presenter (TPP), according to one embodiment. The TPP also offers advanced features such as but not limited to allowing the dental office staff to alter the treatment, select a different specialist, rearrange the order of the treatment to maximize the insurance benefits for the most needed procedures or based on the provider or patient's desires. The TPP could be used instead of the ORKS treatment plan presenter or could pull from the ORKS to create the TPP or any combination thereof.

FIG. 9B illustrates an example of another treatment plan 901 prepared by a treatment plan presenter (TPP) with co-pay ranges based on associated trust scores, according to one embodiment. As illustrated, some of the line items are associated with trust scores less than 100. The trust scores in the examples range from 0 to 100, but any numerical range, letter grade, percentage, color coding scheme, or other comparative assignment may be used instead of a 0-100 numerical range.

According to various embodiments, a trust score may be based on what information is verified, confirmation of the accuracy of the information, the possibility of holding the provider of the data accountable for errors, etc. For example, data received from an insurance company may be associated with different levels of confidence, that may factor into the trust score, based on a range of factors and quality of sources. An example spectrum of accuracy for data retrieval sources might include phone calls to the insurance company, electronic verification using existing e-verify tools, post hoc verification of past claims, faxback information, online portals, API requests, insurance representative conversations, externally accessible databases, and learned data based on prior claim processing.

A trust score may be based on the quality or confidence level associated with the data obtained from insurance carriers and/or specialists. The treatment plan presented may use coverage estimate information with a trust score above a certain threshold value and assume a worst-case scenario for those coverage estimates associated with a trust score below a threshold value. In other embodiments, the treatment plan may provide a range of possible cost estimates and coverage amounts in conjunction with percentages of likelihood or transparent trust score estimates associated with each value.

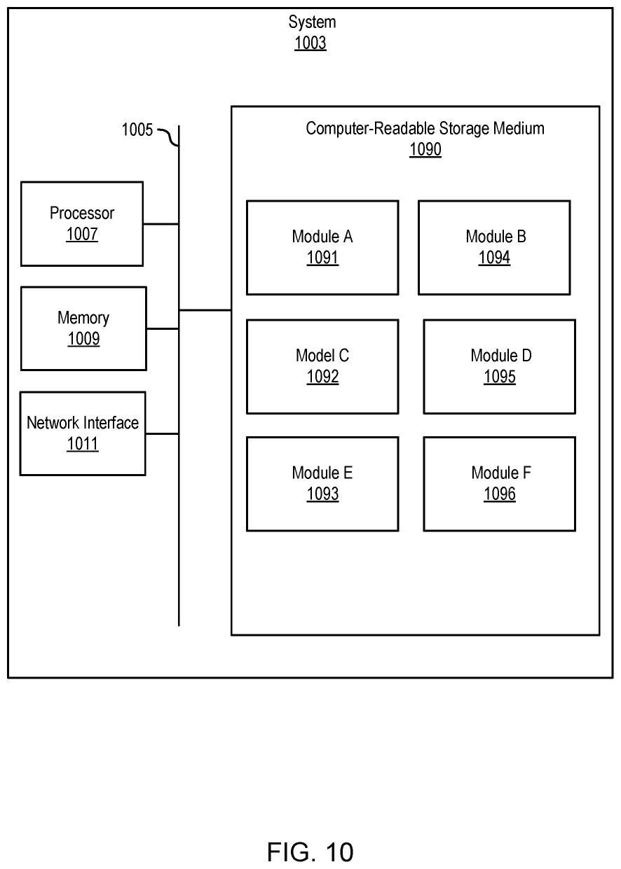

FIG. 10 illustrates a block diagram of one implementation of various embodiments of the system 1003 described herein in which any combination of the named components, functional components, systems, subsystems, or modules is implemented as a module within a computer-readable medium for execution by a processor, according to one embodiment. As illustrated, a bus 1005 may connect a processor 1007, memory 1009, and a network interface 1011 to a non-transitory computer-readable storage medium 1090 with various modules 1091-1096. Each of the modules may implement one or more of the operations, steps, systems, and subsystems described herein.

For example, Module A 1091 may comprise a DCL module to aggregate data from various insurance companies. Module B 1092 implement the DCL to aggregate data from various specialists. Module C 1093 be a single series array module to generate SSA and CCC data structures, as described herein. Module D 1094 may be a treatment plan presented (TTP) module to generate treatment plans. Module E 1094 may be a trust score generation module to generate a trust score and/or associate received data with a confidence score or individual trust score based on the source of the data and/or comparison with previously processed claims in a processed claim database.

According to one example, a system includes a processor, a memory, a database of processed dental insurance claims that includes information identifying at least coverage and patient copay amounts for a plurality of dental procedures, and a non-transitory computer-readable medium with stored instructions. The instructions, when executed by the processor may cause the system to identify a plurality of dental procedures to be performed on a patient. The system may then obtain insurance coverage information from a first insurance provider of the patient for the identified dental procedures using a first type of data retrieval source (e.g., email, electronic request, API, phone call and manual entry into a database, lookup table on a website, insurance card information, etc.).

The system may the obtain insurance coverage information from a second insurance provider of the patient for the identified dental procedures using a second type of data retrieval source (e.g., a different source or the same source). The system may then calculate a co-pay amount that the patient will have to pay for each of the dental procedures based on the insurance coverage information obtained from the first and second insurance providers.

The system may then generate a trust score for each of the calculated co-pay amounts for each dental procedure based on the types of data retrieval sources used to obtain the insurance coverage information from the first and second insurance providers for each of the identified dental procedures. As described herein, some sources may be considered very accurate while other sources may be less reputable or otherwise associated with a lower confidence level for a given treatment or dental procedure.

The system may then compare the calculated co-pay amounts with historical co-pay amounts of previously processed insurance claims for the identified dental procedures in the database of processed dental insurance claims for other patients with the same dental insurance coverage by the first and second insurance providers.

The system may adjust the calculated trust score for each of the calculated co-pay amounts based on the comparison of the calculated co-pay amounts with the historical co-pay amounts for each of the identified dental procedures. For example, the trust score may be increased or stay maximized when the historical co-pay amounts match. Similarly, when the amounts do not match the trust score may be decreased.

The system may then calculate an adjusted co-pay amount, a range of co-pay amounts, worst-case and best-case amounts, or the like for each of the identified dental procedures as a function of the respective calculated co-pay amounts and the respective adjusted trust score amounts.

The system may then generate a treatment plan (e.g., as part of a graphical user interface), as a printout report, as an electronic report, as part of an email, as part of a contract, or the like. The treatment plan may include identification of the dental procedures to be performed, a total expected cost of each of the dental procedures, coverage amounts to be paid by one or both or the combination of the insurance companies, and/or a portion of the total expected cost of each of the dental procedures to be paid for by the patient based on the adjusted co-pay amount of each of the identified dental procedures. The amount to be paid by the patient may be presented as a specific value (e.g., dollar amount), a range of amounts, a best-case amount, a worst-case amount, or as an amount or range coupled with a confidence level. For example, the amount could be presented as “The expected co-pay amount is between $250 and $1,000. We are confident that the amount will be at least $250, but there is a low/fair/high probability that the amount will be as much as $1,000. We are confident that the total amount of the co-pay will not exceed $1,000.” Simpler approaches may be used without so much detail and qualitative words like low, fair, high may correspond to specific threshold numerical values of the adjusted trust score.

It is understood that aspects of the systems and methods described herein can implement or perform one or more of the following: sync data between computers which use non similar languages, exchanges data between first insurance carrier and dental office, sync data between first insurance carrier and dental office, create a DCL that grabs/converts first insurance carrier data into a standard format which can be shared with dental office, create a DCL that syncs data between first insurance carrier and dental office, create a DCL that exchanges data between first insurance carrier and dental office, grab information from dental insurance companies' databases and syncs them to dental office practice management software system, grab information from dental insurance companies' databases and exchanges it with dental office practice management software systems, grab member benefit information from dental insurance companies' databases and syncs them to dental office practice management software systems, grab member benefit information from dental insurance companies' databases and exchanges it with dental office practice management software systems, grab ALL ADA code information from dental insurance companies' databases and sends them to doctor practice management software systems, grab ALL ADA code information from dental insurance companies' databases and syncs them to provider practice management software systems, create a DCL that grabs/converts insurance company data into a standard format that syncs with a dental practice management systems, create a DCL that grabs/converts insurance company data into a standard format and exchanges it with a dental practice management systems, create a DCL that allows the insurance companies to opt in to send their data in a standard format, create a DCL that allows the insurance companies to opt in to exchange their data in a standard format, create a DCL that allows the insurance companies to opt in to sync their data in a standard format, and/or implement or perform other actions and operations described herein.

Some of the infrastructure that can be used with embodiments disclosed herein is already available, such as: general-purpose computers, computer programming tools and techniques, digital storage media, and communications networks. A computer may include a processor, such as a microprocessor, microcontroller, logic circuitry, or the like. The processor may include a special-purpose processing device, such as an ASIC, a PAL, a PLA, a PLD, a CPLD, a Field Programmable Gate Array (FPGA), or other customized or programmable device. The computer may also include a computer-readable storage device, such as non-volatile memory, static RAM, dynamic RAM, ROM, CD-ROM, disk, tape, magnetic, optical, flash memory, or other computer-readable storage medium.

Suitable networks for configuration and/or use, as described herein, include any of a wide variety of network infrastructures. Specifically, a network may incorporate landlines, wireless communication, optical connections, various modulators, demodulators, small form-factor pluggable (SFP) transceivers, routers, hubs, switches, and/or other networking equipment.

The network may include communications or networking software, and may operate using TCP/IP, SPX, IPX, SONET, and other protocols over twisted pair, coaxial, or optical fiber cables; telephone lines; satellites; microwave relays; modulated AC power lines; physical media transfer; wireless radio links; and/or other data transmission “wires.” The network may encompass smaller networks and/or be connectable to other networks through a gateway or similar mechanism.

Aspects of certain embodiments described herein may be implemented as software modules or components. As used herein, a software module or component may include any type of computer instruction or computer-executable code located within or on a computer-readable storage medium, such as a non-transitory computer-readable medium. A software module may, for instance, comprise one or more physical or logical blocks of computer instructions, which may be organized as a routine, program, object, component, data structure, etc., that perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The various functional components of the described systems and methods may be modeled as a functional block diagram that includes one or more remote terminals, networks, servers, data exchanges, and software/hardware/firmware modules configured to implement the various functions, features, methods, and concepts described herein. In many instances, each application, embodiment, variation, option, service, and/or other component of the systems and methods described herein may be implemented as a module of a larger system. Each module may be implemented as hardware, software, and/or firmware, as would be understood by one of skill in the art for the particular functionality and may be part of a larger physical system that may include computer-readable instructions, processors, servers, endpoint computers, and/or the like.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Further, those of skill in the art will recognize that one or more of the specific details may be omitted, or other methods, components, or materials may be used. In some cases, operations are not shown or described in detail. Thus, the detailed description of the embodiments of the systems and methods of the disclosure is not intended to limit the scope of the disclosure, as claimed, but is merely representative of possible embodiments.

What is claimed is:

1. A system, comprising:
a processor;
a memory;
a database of processed dental insurance claims that includes information identifying at least coverage and patient copay amounts for a plurality of dental procedures;
a non-transitory computer-readable medium with instructions stored therein that, when executed by the processor, cause the system to:
identify a plurality of dental procedures to be performed on a patient;
obtain insurance coverage information from a first insurance provider of the patient for the identified dental procedures using a first type of data retrieval source;
obtain insurance coverage information from a second insurance provider of the patient for the identified dental procedures using a second type of data retrieval source;
calculate a co-pay amount that the patient will have to pay for each of the dental procedures based on the insurance coverage information obtained from the first and second insurance providers;
generate a trust score for each of the calculated co-pay amounts for each dental procedure based on the types of data retrieval sources used to obtain the insurance coverage information from the first and second insurance providers for each of the identified dental procedures;
compare the calculated co-pay amounts with historical co-pay amounts of previously processed insurance claims for the identified dental procedures in the database of processed dental insurance claims for other patients with the same dental insurance coverage by the first and second insurance providers;
adjust the calculated trust score for each of the calculated co-pay amounts based on the comparison of the calculated co-pay amounts with the historical co-pay amounts for each of the identified dental procedures,
where each trust score is increased in response to the identification of historical co-pay amounts that match a calculated co-pay amount, and
where each trust score is decreased in response to the identification of historical co-pay amounts that do not match a calculated co-pay amount;
calculate an adjusted co-pay amount for each of the identified dental procedures as a function of the respective calculated co-pay amounts and the respective adjusted trust score amounts; and
generate a treatment plan report for the patient that includes:
identification of the dental procedures to be performed,
a total expected cost of each of the dental procedures, and
a portion of the total expected cost of each of the dental procedures to be paid for by the patient based on the adjusted co-pay amount of each of the identified dental procedures.

2. A system, comprising:
a processor;
a memory;
a database of processed dental insurance claims that includes information identifying at least coverage and patient copay amounts for a plurality of dental procedures;
a non-transitory computer-readable medium with instructions stored therein that, when executed by the processor, cause the system to:
identify a plurality of dental procedures to be performed on a patient;
obtain insurance coverage information from a first insurance provider of the patient for the identified dental procedures using a first type of data retrieval source;
obtain insurance coverage information from a second insurance provider of the patient for the identified dental procedures using a second type of data retrieval source;
calculate a co-pay amount that the patient will have to pay for each of the dental procedures based on the insurance coverage information obtained from the first and second insurance providers;
generate a trust score for each of the calculated co-pay amounts for each dental procedure based on the types of data retrieval sources used to obtain the insurance coverage information from the first and second insurance providers for each of the identified dental procedures;
compare the calculated co-pay amounts with historical co-pay amounts of previously processed insurance claims for the identified dental procedures in the database of processed dental insurance claims for other patients with the same dental insurance coverage by the first and second insurance providers;
adjust the calculated trust score for each of the calculated co-pay amounts based on the comparison of the calculated co-pay amounts with the historical co-pay amounts for each of the identified dental procedures,
where each trust score is increased in response to the identification of historical co-pay amounts that match a calculated co-pay amount, and
where each trust score is decreased in response to the identification of historical co-pay amounts that do not match a calculated co-pay amount;
generate a co-pay range for each of the identified dental procedures as a function of the respective calculated co-pay amounts and the respective adjusted trust score amounts; and
generate a treatment plan report for the patient that includes:
identification of the dental procedures to be performed,
a total expected cost of each of the dental procedures, and
the co-pay range of each of the dental procedures to be paid for by the patient based on the adjusted co-pay amount of each of the identified dental procedures.

3. The system of claim 2, wherein the co-pay range is a single number for each of the identified dental procedures for which the adjusted trust score amount is above a threshold trust score value.

4. The system of claim 2, wherein the trust score is a numerical value between 0 and 100.
